(19) United States
(12) Patent Application Publication
(10) Pub. No.: US 2007/0165278 A1
(43) Pub. Date: Jul. 19, 2007

(54) Printer

(75) Inventor: Naoki Nakajo, Shiojiri (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/654,969

(22) Filed: Jan. 17, 2007

(30) Foreign Application Priority Data
Jan. 17, 2006 (JP) 2006-008867

(51) Int. Cl. G06K 15/00

(52) U.S. Cl. 358/1.16

(57) ABSTRACT

A printing apparatus is operable to read out data from a first recording medium and to execute printing based on the read-out data. A command receiver is adapted to receive, from an operator, a command for executing backup of the data in the first recording medium on a second recording medium. A message provider is operable to provide a message for prompting the operator to execute printing on a surface of the second recording medium when the command receiver receives the command.

### BACKGROUND

1. Technical Field

The present invention relates to a printer, and more particularly, to a printer for reading an image file from an inserted portable recording medium and performing printing.

2. Related Art

The popularization of digital cameras has led to an increasing request for direct printers that are directly connected with a portable recording medium (for example, a memory card) without a host computer to perform printing.

Some of those direct printers can directly perform printing on a label surface of a CD-R. In such a direct printer, in addition to general trays for paper, a tray for mounting a CD-R is provided. Such a configuration is disclosed in Japanese Patent Publication No. 2003-1873A (JP-A-2003-1873).

When performing label printing using an image in a memory card, a user sets a CD-R on a printing tray, selects an image to be printed, and issues an command to perform printing.

A direct printer provided with a backup tray the file in a memory card onto a CD-R has been proposed.

When a direct printer having the above-mentioned structure appears, a user first sets a CD-R on a tray and backs up a file in a memory card. Next, the user moves the CD-R to a tray for label printing, and specifies and prints any one image in the memory card.

However, the file in the memory card is generally deleted after making a backup of the file. Then, it is impossible to perform label printing after making the backup of the file.

In view of this, a method of storing an image having been backed up in a printer can be considered. However, it is difficult from the viewpoint of cost to provide a memory for that purpose to a direct printer.

### SUMMARY

It is therefore one advantageous aspect of the invention to provide a printer that has a function of performing backing up onto, for example, a CD-R and performs label printing more reliably.

According to one aspect of the invention, there is provided a printing apparatus, operable to read out data from a first recording medium and to execute printing based on the read-out data, comprising:

a command receiver, adapted to receive, from an operator, a first command for executing backup of the data in the first recording medium on a second recording medium; and

a message provider, operable to provide a message for prompting the operator to execute printing on a surface of the second recording medium when the command receiver receives the first command.

The message provider may be operable to provide the message before the data in the first recording medium is deleted.

The message provider may be operable to provide the message after the backup is completed.

The command receiver may be adapted to receive, from the operator, a second command for deleting the data in the first recording medium; and

the message provider is operable to provide the message in a case where the printing on the surface of the second recording medium has not been executed when the command receiver receives the second command.

The message provider may be operable to provide the message before the backup is executed.

The printing apparatus may further comprise an eraser, operable to delete the file in the first recording medium after the printing on the surface of the second recording medium is completed.

The message provider may be operable to provide the message every time the backup is completed for every second recording medium, in a case where the data is backed up on a plurality of second recording medium.

The message provider may be operable to provide the message after the backup is wholly completed, in a case where the data is backed up on a plurality of second recording medium.

The second recording medium may be a disk-type recording media, and the printing may be performed on a label face of the disk-type recording medium.

The first recording medium may be a portable recording medium.

According to one aspect of the invention, there is provided a method executed in a printing apparatus operable to read out data from a first recording medium and to execute printing based on the read-out data, comprising:

receiving, from an operator, a first command for executing backup of the data in the first recording medium on a second recording medium; and

providing a message for prompting the operator to execute printing on a surface of the second recording medium when the command receiver receives the first command.

### BRIEF DESCRIPTION OF THE DRAWINGS

FIG. 1 is a block diagram showing a printer according to a first embodiment of the invention.

FIG. 2 is a block diagram showing a functional configuration of a controller in the printer.

FIG. 3 is a flowchart showing backup processing performed in the printer.

FIG. 4 shows screen transitions which are displayed on a display in a control panel of the printer in accordance with the processing shown in FIG. 3.

FIG. 5 is a flowchart showing backup processing performed in a printer according to a second embodiment.

FIG. 6 shows screen transitions which are displayed on the display in accordance with the processing shown in FIG. 5.

### DETAILED DESCRIPTION OF EXEMPLARY EMBODIMENTS

Exemplary embodiments of the invention will be described with reference to the accompanying drawings.

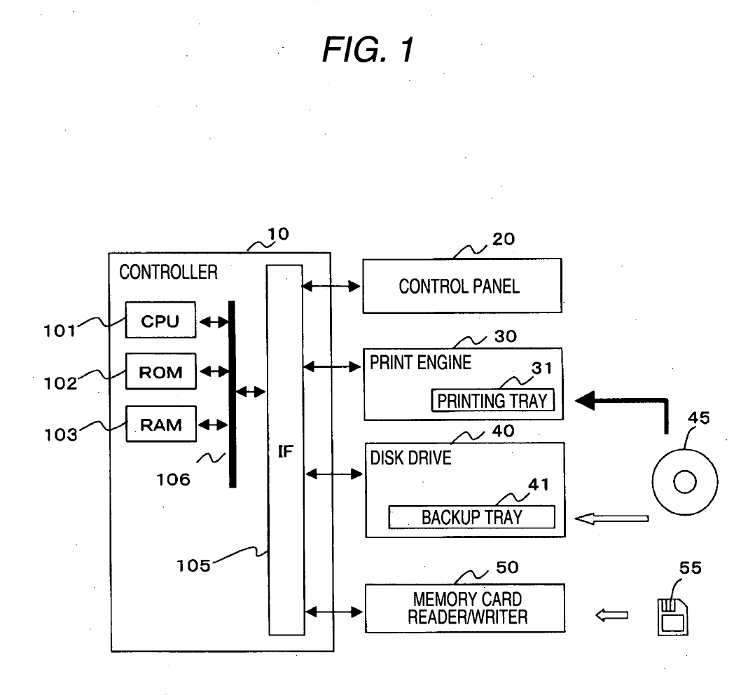

FIG. 1 shows a printer according to a first embodiment of the invention. The printer according to this embodiment is a direct printer that is adapted to be directly connected with a portable recording medium (memory card) 55 without a host computer to perform printing. However, the printer can be connected with a host computer, receive a control command from a printer driver to perform printing. Also, the printer can perform printing using a digital camera as a host.

As shown in FIG. 1, the printer includes a controller 10 for performing various processing for printing, a control panel 20, a print engine 30 for performing printing, a disk drive 40, and a memory card reader/writer 50. In this embodiment, a case of using a CD-R 45 as a recording medium for backup will be described. However, the recording medium for backup is not limited thereto, but it may be any of a CD-RW, a DVD-R, a DVD-RW, etc. In this case, a driver suitable for the type of recording medium is installed on the printer.

The controller 10 includes a CPU 101, serving as a main controller, a ROM 102 storing programs and so on, a RAM 103 serving as a main memory and temporarily storing data and so on, an interface 105 for controlling input and output with respect to, for example, the control panel 20, and a system bus 106 serving as a communication path among the individual components. The interface 105 may be an ASIC designed to exclusively perform each process.

The control panel 20 is composed of, for example, a liquid crystal display device or operation buttons, and takes charge of a user interface function of receiving a layout command, accepting selection of an image file to be printed, or receiving a backup request of a file in a memory card from a user.

The print engine 30 performs a printing operation based on image data under control of the controller 10. The print engine 30 includes a printing tray 31 for mounting a CD-R 45 and a mechanism for sending the CD-R 45 together with the printing tray 31 to a position opposing a printing head when label printing is performed.

The disk drive 40 reads a file recorded on the CD-R 45 and transmits the file to the controller 10. Also, according to a command of the controller 10, the disk drive 40 performs recording of the file on the CD-R 45. For this reason, the disk drive 40 has a backup tray 41 for mounting the CD-R 45.

The memory card reader/writer 50 reads a file recorded in the memory card 55 and transmits the file to the controller 10. Also, according to a command of the controller 10, the memory card reader/writer 50 performs deleting or updating of a file recorded in the memory card 55.

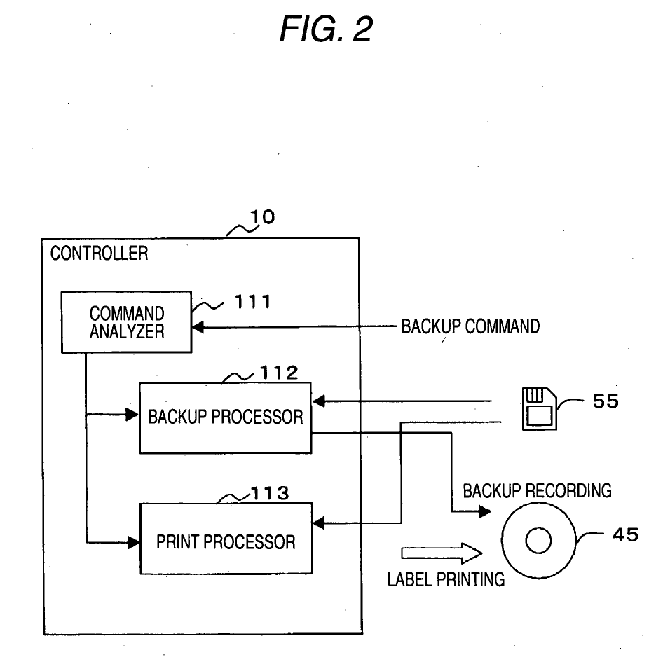

FIG. 2 shows an example of the functional configuration of the controller 10. Each functional component can be realized in a software or hardware manner.

As shown in FIG. 2, the controller 10 includes an command analyzer 111, a backup processor 112, and a print processor 113.

The command analyzer 111 analyzes a request input through the control panel 20 by the user and commands each functional component to perform processing according to the request. For example, when the command analyzer 111 receives a file backup request, it instructs the backup processor 112 to perform processing for backup.

The backup processor 112 performs processing of recording a file recorded in the memory card 55 on the CD-R 45 to make a backup of the file.

The print processor 113 reads image data to be printed from the memory card 55, converts the read image data into printing data, and performs printing through the print engine 30. For example, the print processor 113 extracts an image selected by the user from the memory card 55, performs color conversion on the image, transmits the converted image to the print engine 30, and prints the image on a label surface of a CD-R.

Next, the operation of the printer having the above-mentioned configuration will be described. As described above, the printer according to this embodiment has a function of backing up a file recorded in the memory card 55 onto the CD-R 45. Further, the printer has also a function of printing a label on a CD-R. After making a backup of a file, if record contents of the memory card 55 are deleted, then, even though the user wants to perform label printing using the image having been deleted from the memory card 55, it is impossible to do that.

In this embodiment, in order to reliably perform label printing, it is configured such that label printing is performed before data in the memory card 55 is deleted.

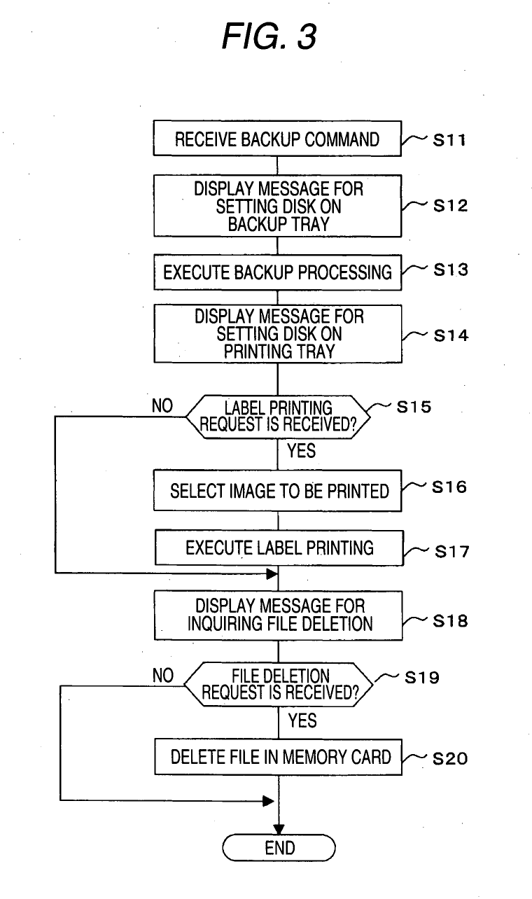

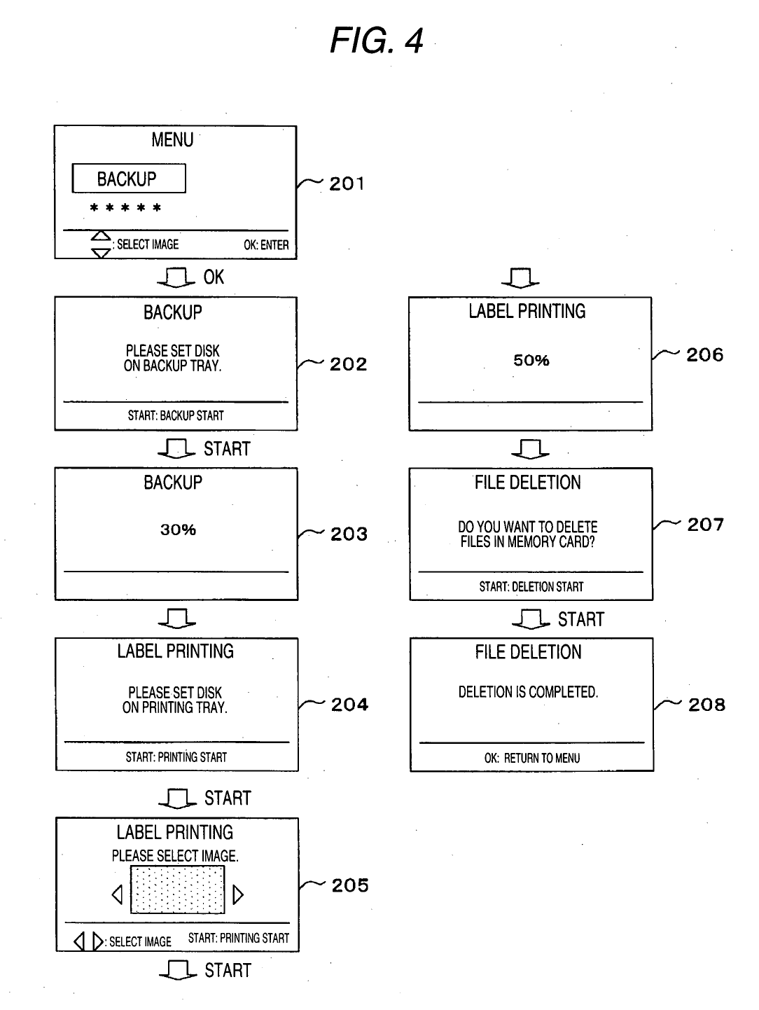

FIGS. 3 shows a flow of backup processing executed when a backup command is received, and FIG. 4 shows screens displayed on a display in the control panel 20 in accordance with the processing flow.

As shown in a screen 201 of FIG. 4, in an initial menu screen, when “backup” is selected and then an OK button is pushed, backup processing starts.

When the command analyzer 111 receives a backup request in this way, it instructs the backup processor 112 to start processing for backup (Step S11).

When receiving that command of the command analyzer 111, the backup processor 112 displays a message prompting the user to set the CD-R 45 on the backup tray 41 for backup, such as a massage “Please set disk on backup tray”, on the display of the control panel 20, as shown in a screen 202 of FIG. 4 (Step S12).

Next, the backup processor 112 performs processing of recording the record contents in the memory card 55 on the CD-R 45. Specifically, the backup processor 112 reads a file in the memory card 55 through the memory card reader/writer 50 and writes the file on the CD-R 45 through the disk drive 40. In the recording processing, the backup processor 112 performs display as shown in a screen 203 of FIG. 4 (Step S13).

When the backup processing is completed, the backup processor 112 performs display of a message prompting the user to set the CD-R 45 on the printing tray 31 for printing and perform label printing, such as a message “Please set disk on printing tray”, as shown in a screen 204 of FIG. 4. Then, the backup processor 112 is placed in a standby state until a label print request is received from the user (Step S14).

When label printing is not requested (No in Step S15), the backup processor 112 performs processing of Step S18 without performing label printing.

Meanwhile, when label printing is requested (Yes in Step S15), the backup processor 112 instructs the print processor 113 to perform label printing. When receiving this command, the print processor 113 accepts selection of an image to be printed. Specifically, the print processor 113 sequentially reads images recorded in the memory card 55, displays the read-out images on the display of the control panel 20 as shown in a screen 205 of FIG. 4, and accepts selection from the user (Step S16).

Then, when an image is selected and then a print request is received from the user, the print processor 113 performs label printing on the CD-R 45. In the process of printing, display as a screen 206 of FIG. 4 is performed (Step S17).

When the printing operation is completed, the backup processor 112 displays a message inquiring whether to perform deleting or not, such as a message “Do you want to delete files in memory card?”, as shown in a screen 207 of FIG. 4, and is placed in a standby state until a deletion request is received (Step S18).

When deletion is not requested (No in Step S19), the backup processor 112 completes the backup processing.

When deletion is requested (Yes in Step S19), the backup processor 112 deletes the record contents in the memory card 55 through the memory card reader/writer 60, performs display as shown in a screen 208 of FIG. 4, and completes the backup processing. Then, the screen is changed to the initial menu screen.

According to this embodiment, before data in the memory card is deleted, it is possible to reliably perform label printing.

In order to reliably perform label printing, it is preferable that, before the data in the memory card 55 is deleted, a message prompting the user to execute label printing is output and label printing is performed in response to a request from the user. That is, the embodiment of the invention is not limited to the processing flow shown in FIG. 3, but can be variously modified.

For example, it is possible to output a message prompting the user to execute a label printing after the backup request is received but before the backup processing starts.

When the user requests that deleting of the data in the memory card 55 is performed, the backup processor 112 determines whether or not backup processing and a label printing have been performed. When it is determined that the backup processing has been performed and the label printing has not been performed, a message prompting the user to execute a label printing may be output.

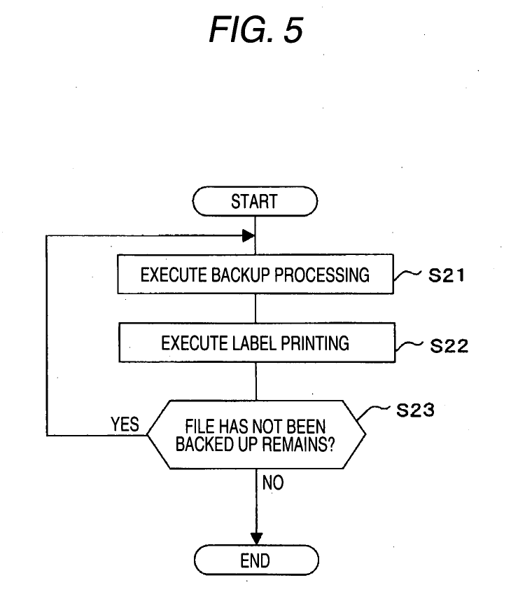

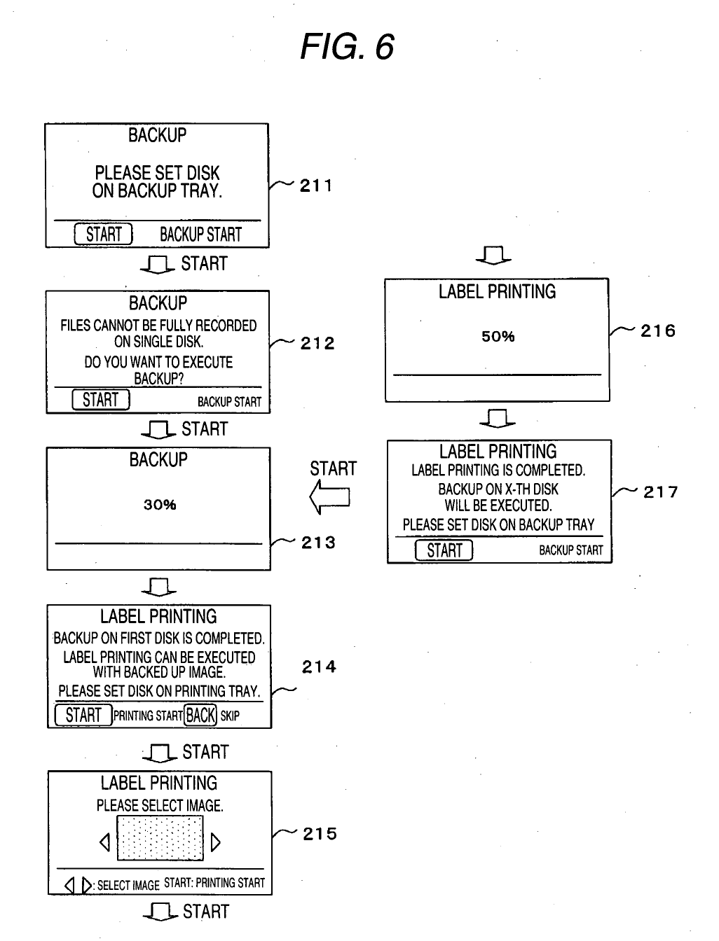

Next, a second embodiment of the invention will be described with reference to FIGS. 5 and 6.

In a case where all the file to be backed up cannot be stored into one recording medium for backup (CD-R 45), backup is performed with respect to a plurality of recording media for backup. Even in this case, it is necessary to reliably perform label printing on the individual recording media for backup. In this embodiment, whenever the backup onto each CD-R 45 is completed, the backup processor outputs a message prompting the user to execute a label printing and is placed in a standby state until receiving a label print request. Alternatively, it is possible that, after the file to be backed up is wholly backed up onto the plurality of CD-Rs 45, the backup processor outputs a message prompting the user to execute label printing on each CD-R 45 and is placed in a standby state until receiving a label print request.

When receiving a backup request from the user, the backup processor 112 displays a message prompting the user to set the CD-R 45 on the backup tray 41 for backup, as shown in a screen 211 of FIG. 6. Then, the backup processor 112 checks the free space of the set CD-R 45 and determines whether the file in the memory card 55 can be wholly recorded on the CD-R 45. Also, when the user selects a file to be backed up, the backup processor 112 determines whether the selected file can be wholly recorded on the set CD-R 45. When the selected file can be wholly recorded on the set CD-R 45, similar to the first embodiment, the backup processor 112 performs a backup processing. Meanwhile, when the selected file cannot be wholly recorded on the set CD-R 45, the processor 112 displays a message notifying the user that the selected file cannot be fully recorded into one CD-R 45, and is placed in a standby state until receiving a backup starting request from the user, as shown in a screen 212 of FIG. 6.

Then, when receiving a backup starting request, the backup processor 112 reads data of the file from the memory card 55 by an amount capable of being stored in the free space of the set CD-R 45, and records the read data on the CD-R 45 (see Step S21 in FIG. 5 and a screen 213 in FIG. 6). When the record capacity of the CD-R 45 is filled, the backup processor notifies the user that the backup processing is completed, and simultaneously, displays a message prompting the user to execute label printing on the backup CD-R 45, as shown in a screen 214 of FIG. 6.

When a label print request is received, similar to the above-mentioned embodiment, the print processor 113 accepts the selection of an image to be printed (see a screen 215 of FIG. 6) and then performs label printing (see Step S22 in FIG. 5 and a screen 216 in FIG. 6). Then, it is checked whether a portion of the file that has not been backed up exists in the memory card 55. When a portion of the file that has not been backed up exists in the memory card 55 (Yes in Step 23), as shown in a screen 217 of FIG. 6, a message prompting the user to set a new CD-R is displayed and the process returns to the backup processing (Step S21). Meanwhile, when the file has been wholly backed up (No in Step S23), the backup processor 112 completes the backup processing.

Therefore, even when a plurality of CD-Rs 45 are used in the backup process, it is possible to reliably perform label printing on each CD-R 45.

A recording medium serving as a backup source is not limited to a memory card, but may be a portable recording medium, such as a USB memory or a small hard disk, capable of being inserted into a digital camera.

In the above embodiments, a printer is exemplified as a printing apparatus. However, the invention is applicable to a hybrid apparatus having the functions of a copier, a scanner, a facsimile, etc.

Although only some exemplary embodiments of the invention have been described in detail above, those skilled in the art will readily appreciated that many modifications are possible in the exemplary embodiments without materially departing from the novel teachings and advantages of the invention. Accordingly, all such modifications are intended to be included within the scope of the invention.

The disclosure of Japanese Patent Application No. 2006-8867 filed Jan. 17, 2006 including specification, drawings and claims is incorporated herein by reference in its entirety.

What is claimed is:

1. A printing apparatus, operable to read out data from a first recording medium and to execute printing based on the readout data, the apparatus comprising:
a command receiver, adapted to receive, from an operator, a first command for executing backup of the data in the first recording medium on a second recording medium; and
a message provider, operable to provide a message for prompting the operator to execute printing on a surface of the second recording medium when the command receiver receives the first command.

2. The printing apparatus as set forth in claim 1, wherein:
the message provider is operable to provide the message before the data in the first recording medium is deleted.

3. The printing apparatus as set forth in claim 1, wherein:
the message provider is operable to provide the message after the backup is completed.

4. The printing apparatus as set forth in claim 1, wherein:
the message provider is operable to provide the message before the backup is executed.

5. The printing apparatus as set forth in claim 3, wherein:
the command receiver is adapted to receive, from the operator, a second command for deleting the data in the first recording medium; and
the message provider is operable to provide the message in a case where the printing on the surface of the second recording medium has not been executed when the command receiver receives the second command.

6. The printing apparatus as set forth in claim 1, further comprising:
an eraser, operable to delete the file in the first recording medium after the printing on the surface of the second recording medium is completed.

7. The printing apparatus as set forth in claim 1, wherein:
the message provider is operable to provide the message every time the backup is completed for every second recording medium, in a case where the data is backed up on a plurality of second recording medium.

8. The printing apparatus as set forth in claim 1, wherein:
the message provider is operable to provide the message after the backup is wholly completed, in a case where the data is backed up on a plurality of second recording medium.

9. The printing apparatus as set forth in claim 1, wherein:
the second recording medium is a disk-type recording media, and the printing is performed on a label face of the disk-type recording medium.

10. The printing apparatus as set forth in claim 1, wherein:
the first recording medium is a portable recording medium.

11. A method executed in a printing apparatus operable to read out data from a first recording medium and to execute printing based on the read-out data, the method comprising:
receiving, from an operator, a first command for executing backup of the data in the first recording medium on a second recording medium; and
providing a message for prompting the operator to execute printing on a surface of the second recording medium when the command receiver receives the first command.
